(19) United States
(12) Patent Application Publication
(10) Pub. No.: US 2004/0237658 A1
(43) Pub. Date: Dec. 2, 2004

(54) Capacitive micromechanical pressure sensor

(76) Inventors: Torsten Ohms, Gerlingen (DE); Gottfried Flik, Leonberg (DE); Gilbert Moersch, Stuttgart (DE); Oliver Stoll, Reutlingen (DE)

Correspondence Address: KENYON & KENYON, ONE BROADWAY, NEW YORK, NY, 10004, US

(21) Appl. No.: 10/809,986

(22) Filed: Mar. 26, 2004

(30) Foreign Application Priority Data
Mar. 27, 2003 (DE) 10313738.6

(51) Int. Cl. G01L 9/12

(52) U.S. Cl. 73/718

(57) ABSTRACT

A method for manufacturing a micromechanical pressure sensor and a pressure sensor manufactured using this method. The pressure is measured in the pressure sensor composed of at least two components via a capacitance measurement of a capacitor, the pressure sensor having at least one first electrode and one first diaphragm. The movement of the diaphragm causes a change in the capacitance of the capacitor which may be used in the capacitance measurement as a measure for the pressure variable to be measured. It is important that, prior to assembly, the first and the second components of the pressure sensor be processed separately. The first component has at least one semiconductor material and the first electrode, whereas the second component is made of metal, at least in part, and contains at least the first diaphragm.

### FIELD OF THE INVENTION

The present invention relates to a micromechanically manufacturable capacitive pressure sensor which is composed of two differently processed components, the first component being made of a semiconductor material and the second component, at least in part, being made of metal.

### BACKGROUND INFORMATION

Sensors of different designs are conceivable for measuring pressure. Different measuring principles, in particular in micromechanical construction, have emerged in the past few years. The measurement of changes in the capacitance in a micromechanical pressure sensor, designed as a capacitor, represents a current method of micromechanical pressure measuring. A capacitive pressure sensor, which may be manufactured micromechanically, is known from German Patent Application No. DE 101 21 394, for example. The micromechanical pressure sensor is implemented by a semiconductor component, the pressure sensor being composed of a diaphragm electrode, a bottom electrode, and a cavity situated between the two electrodes. Due to the pressure difference between the pressure prevailing in the cavity and the external pressure, deflection of the diaphragm occurs and thus a change in the distance between the electrically conductive diaphragm and the capacitor plates situated opposite this diaphragm.

A micromechanical component, also usable as a pressure sensor, is known from German Patent Application No. DE 100 24 266. A functional layer made of semiconductor material is epitactically applied to a substrate also made of a semiconductor material, a cavity, defining a diaphragm area of the functional layer, being provided partly between the substrate and the functional layer. Using the functional layer, the cavity, and an electrode produced in the substrate, a capacitance measurement may be performed under different external pressures.

### SUMMARY OF THE INVENTION

The present invention provides a manufacturing method of a micromechanical pressure sensor and a micromechanical pressure sensor manufactured using this method. The pressure measurement in the pressure sensor, composed of at least two components, takes place via a capacitance measurement of a capacitor, the pressure sensor having at least a first electrode and a first diaphragm. The movement of the diaphragm causes a change in the capacitance of the capacitor which, in the capacitance measurement, may be used as a measure for the pressure variable to be measured. A core of the present invention lies in the fact that, prior to their assembly, the first component and the second component of the pressure sensor are processed in separate manufacturing processes. In particular, the first component is made of at least one semiconductor material and has the first electrode, whereas the second component is at least in part made of metal and contains at least the first diaphragm.

In a further embodiment of the present invention, the capacitance measurement of the pressure sensor is performed via a second electrode of a capacitor. In this case, the second electrode can be part of the first component or part of the second component. In a particular design of the pressure sensor it is furthermore provided that the second electrode in the second component is implemented by the first diaphragm.

It is provided according to the present invention that the second component includes a metal diaphragm. In contrast to the traditional pressure sensors having semiconductor diaphragms, the use of this metal diaphragm results in increased rigidity of the diaphragm and thus in a higher measurable pressure range along with a compact design. In addition, it is provided in a particular embodiment of the present invention to implement the metal diaphragm as a steel diaphragm.

The first component advantageously includes at least part of a circuit for analyzing the capacitance measurement; individual circuit elements may also be considered as part of the circuit. In particular, the circuit is situated on the side of the first component opposite the first electrode. Furthermore, the part of the circuit using an electric connection which runs within the first component is bonded to the first electrode on or in the first component.

In a refinement of the present invention, the first and the second components are connected to one another via a non-conductive material. Using this non-conductive material, it can be achieved that the combination of first and second component holds firmly together without causing an electric contact between the two components.

In a particular embodiment of the present invention the second electrode in the first component is designed to be moveable with respect to the first electrode. In particular, an electric contact is run from the second electrode through the first component to the circuit. The movement of the second electrode advantageously follows the movement of the diaphragm; in particular, the second electrode does not bend during the movement. This has the advantage that the movement of the diaphragm makes the second electrode approach the first electrode in parallel.

Further advantages of the present invention, in particular advantages regarding the manufacturing method of the capacitive micromechanical pressure sensor, arise from the following exemplary embodiments.

### BRIEF DESCRIPTION OF THE DRAWINGS

FIGS. 1a, 1b, 2, 3a, 3b and 4 illustrate different exemplary embodiments which may be implemented using the present invention.

### DETAILED DESCRIPTION

The present invention relates to a capacitive micromechanical pressure sensor and to a method for manufacturing a capacitive micromechanical pressure sensor. The pressure sensor is composed of at least two components, a first component including at least one semiconductor material and a second component including a metal, at least in part. A core of the present invention lies in the fact that, in a first step, the first and the second components are processed separately using different manufacturing methods and, in a second step, are subsequently combined forming the pressure sensor.

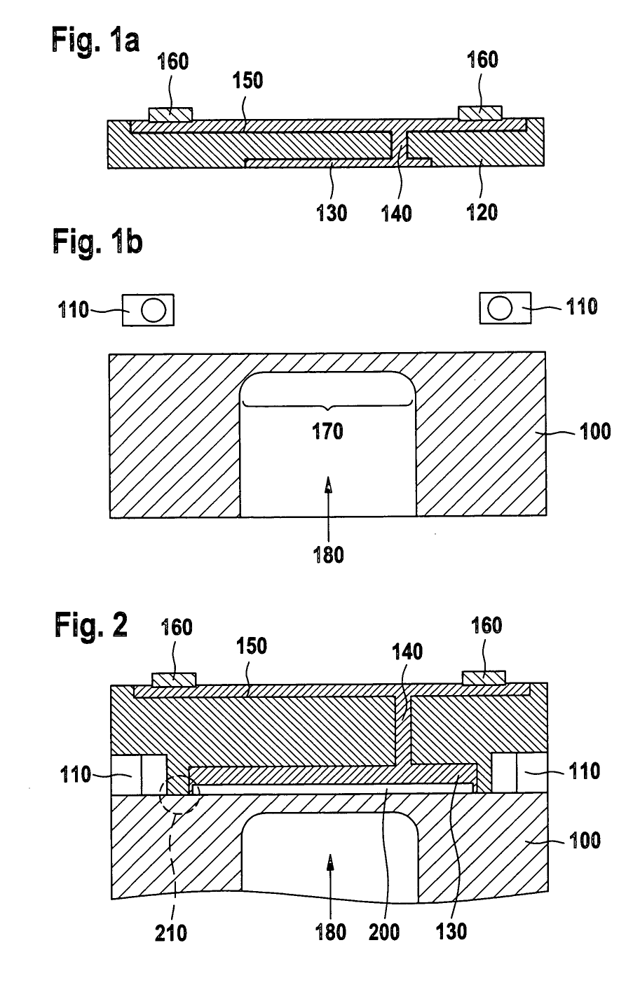

In a preferred exemplary embodiment, a steel substrate as second component 100 is used as a base element. After appropriate manufacture, this steel substrate has a thin steel diaphragm 170 in an area, as is illustrated in FIG. 1b in a cross section through steel substrate 100, for example. External pressure 180 acts upon this steel diaphragm 170 during a pressure measurement, causing steel diaphragm 170 to bend.

In a preferred exemplary embodiment, a semiconductor substrate 120 as a first component is illustrated in such a way that on the underside of substrate 120 a doped area may act as a counter-electrode 130. In the present exemplary embodiment silicon is used as semiconductor substrate 120; however, any other semiconducting material, which may be processed using the methods described here, may be used. In a further exemplary embodiment, at least a part of circuit 150 for analyzing the measured variables produced by the pressure sensor is located on the side opposite counter-electrode 130. Individual circuit elements may also be present in addition to the complete analyzing circuit. Counter-electrode 130, designed as a capacitor plate, is connected to the circuit elements or the analyzing circuit 150 on the top side of the substrate via a contact lead-through (via) 140. An electric connection between circuit 150 and steel diaphragm 170 is necessary for complete analysis of the measuring signals in analyzing circuit 150. This connection may be established either via bonded connections or metal contacts, illustrated as block 160 in FIG. 1a. The analyzed measuring signal may subsequently be used for further processing via an additional contact connection or an additional metal contact.

A simple exemplary embodiment for manufacturing a capacitive micromechanical pressure sensor according to the present invention is represented in that the first component is composed of a flat, round plate made of silicon 120 having a doped bottom side 130, a contact lead-through 140, and a top side including supply leads, metal contacts 160, and possibly an analyzing circuit 150, and that the first component together with second component 100, designed as a steel substrate, are combined, forming the capacitive micromechanical pressure sensor. The combination takes place by applying first component 120 onto second component 100, the two components being electrically insulated from one another by structured seal glass elements 110, for example. Seal glass elements 110 perform an additional function in that a defined distance between the steel substrate, usable as a capacitor electrode, and counter-electrode 130 is ensured using these seal glass elements 110. The seal glass contains spacers (glass balls) for defined adjustment of the distance between the two electrodes. Seal glass elements 110 must be positioned in such a way that the deflection of steel diaphragm 170 is not hindered. Simultaneously, it should be ensured that silicon plate 120 is not bent. Therefore, the silicon edge must rest on the ideally unstressed edge of steel substrate 100. In a further embodiment of the present invention, steel diaphragm 170, seal glass elements 110, as well as semiconductor substrate 120 may enclose a cavity 200 having a defined gas pressure. This may be achieved, for example, in that steel diaphragm 170 is completely enclosed by a seal glass element 110 on steel substrate 100 and the first and second component are bonded using an appropriate sealing adhesive so that cavity 200, so created, is outwardly sealed.

If the manufactured capacitive pressure sensor is subjected to an external pressure 180, i.e., if external pressure 180 is exerted on steel diaphragm 170, steel diaphragm 170 bends according to the pressure difference between external pressure 180 and the cavity pressure. Due to bending of steel diaphragm 170, a change in the capacitance, supplying a measuring signal proportionally to the applied external pressure 180, may be measured in the pressure sensor.

In a further exemplary embodiment, in addition to counter-electrode 130, substrate 120 includes structured spacers in the substrate, as indicated in FIG. 2 in area 210, for example. These spacers create cavity 200, which may be provided with a reference pressure. Furthermore, a receptacle groove may be structured at the edges of the capacitor plates in the semiconductor substrate. In order to accept larger quantities of seal glass, the receptacle groove may be substantially deeper than the plate distance between the two electrodes. In this exemplary embodiment, the distance is not established by the spacers (seal glass-glass balls 110) but rather by structure 210 of substrate 120. The receptacle grooves are open on the sides so that excess seal glass is pushed to the edge and may be discharged. Structure 210 may be produced using traditional micromechanical processes. The receptacle grooves and the spacers are manufactured via high-rate edging (trenching) from the backside. The metal plating and the analyzing circuit may be structured on the front side in a separate process.

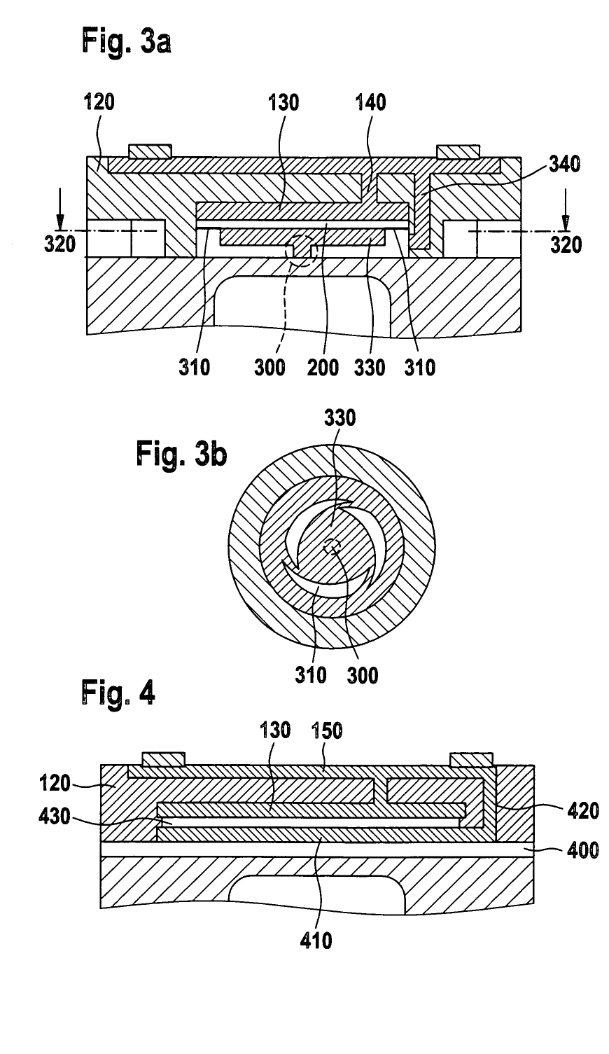

While in the previously presented exemplary embodiments, illustrated in FIGS. 1 and 2, one electrode of the plate capacitor was designed for capacitive pressure measurement by steel substrate 100 and the second electrode as a counter-electrode 130 in substrate 120, additional exemplary embodiments offer the possibility of accommodating both electrodes of the plate capacitor in substrate 120. For example, in addition to counter-electrode 130, electrode 330 may be designed in substrate 120 in such a way that electrode 330 is suspended on microstructured springs 310 opposite counter-electrode 130. A possible design of this suspension 310 is illustrated in FIGS. 3a and 3b. In this particular exemplary embodiment, a punch, as illustrated in section 300 in FIG. 3a, is provided for transferring the position changes of steel diaphragm 170 to electrode 330. When steel diaphragm 170 bends, the position change is directly transferred to electrode 330 via punch 300, permitting a change in the capacitance in the pressure sensor to be verified. Springs 310 have a low prestress, so that punch 300 is pressed onto steel diaphragm 170. Decrease in external pressure 180 allows for maintaining the contact of punch 300 with steel diaphragm 170. The prestress may be set via the ratio of the outer spacers to the punch length in the center. Receptacle grooves at the edge of substrate 120 are in turn provided for securing substrate 120 using seal glass. If appropriately dimensioned, this exemplary embodiment has the advantage that, due to the deflection of the diaphragm center, the entire electrode 330 is displaced in parallel. The change in the capacitance is thus greater than in a measurement using a steel diaphragm 170 as an electrode in which the edges always remain in the original position. For contacting electrode 330 with analyzing circuit 150, a separate electric connection 340 through the substrate is provided in the present exemplary embodiment.

For the purpose of illustrating a possible design of the suspension of electrode 330, a top view of cross section 320 through FIG. 3a is shown in FIG. 3b. Electrode 330 including subjacent punch 300 and suspension springs 310 can be seen in this top view.

A further exemplary embodiment of the present invention is shown in FIG. 4. A second rigid electrode 410 is produced in semiconductor substrate 120. This second electrode 410 is situated directly opposite counter-electrode 130 and encloses cavity or cavern 430. Second electrode 410 is connected to analyzing circuit 150 on the top side of substrate 120 via a separate contact 420 through substrate 120. First component 120, structured in this way, is bonded onto the steel diaphragm or onto steel substrate 100 using seal glass, for example. A deflection of steel diaphragm 170 thus also causes bending of silicon diaphragm 410, while the substantially thicker counter-electrode 130 remains essentially flat. The approach of silicon diaphragm 410 to counter-electrode 130 in turn causes a change in the capacitance.

In a further exemplary embodiment, counter-electrode 130 is not produced as a doped section of semiconductor substrate 120, but is rather applied separately as a conductive layer. It is likewise conceivable that only diaphragm 170 of the second component is made of steel, at least in part, while the rest of the material of the second component may be made of a semiconductive or non-conductive material.

What is claimed is:

1. A capacitive micromechanical pressure sensor comprising:
a first component including a first electrode, the first component including a semiconductor material; and
a second component including a first diaphragm, the second component being at least partially composed of metal,
wherein a capacitive is measured via at least the first electrode and a movement of the first diaphragm, and
wherein the first and second components are processed separately.

2. The pressure sensor according to claim 1, wherein one of the first component and the second component includes a second electrode, the capacitance being measured via the second electrode.

3. The pressure sensor according to claim 2, wherein the second electrode is in the second component and is implemented by the first diaphragm.

4. The pressure sensor according to claim 1, wherein the second component has a steel diaphragm.

5. The pressure sensor according to claim 1, wherein the first component has at least a part of a circuit for analyzing a capacitance measurement, the circuit being situated on a side of the first component opposite the first electrode, the first electrode being contacted with the circuit via an electric connection within the components.

6. The pressure sensor according to claim 1, further comprising a non-conductive material connecting the first and second components to one another.

7. The pressure sensor according to claim 2, wherein the second electrode is moveable with respect to the first electrode in such a way that a movement of the second electrode takes place as a function of a movement of the first diaphragm, a distance between the first and second electrodes changing linearly with the movement of the first diaphragm.

8. A method for manufacturing a capacitive micromechanical pressure sensor, the method comprising:
providing a first component including a first electrode, the first component including a semiconductor material; and
providing a second component including a first diaphragm, the second component being at least partially composed of metal,
wherein a capacitance is measured via at least the first electrode and the first diaphragm,
wherein the first and second components are processed differently, and
wherein the pressure sensor is manufactured by assembling the first and second components.

9. The method according to claim 8, further comprising producing a second electrode in one of the first component and the second component.

10. The method according to claim 9, wherein the second electrode in the second component is implemented by the first diaphragm.

11. The method according to claim 8, further comprising producing at least a part of a circuit for analyzing a capacitance measurement one of in and on the first component.

12. The method according to claim 11, wherein the circuit is produced on a side of the first component opposite the first electrode, and wherein the first electrode is contacted with the circuit via an electric connection within the components.

13. The method according to claim 8, wherein the first and second components are connected to one another by a non-conductive material.

14. The method according to claim 9, wherein the second electrode in the first component is movable with respect to the first electrode in such a way that a movement of the second electrode takes place as a function of a movement of the first diaphragm, a distance between the first and second electrodes changing linearly with the movement of the first diaphragm.
